(19) United States
(12) Patent Application Publication
(10) Pub. No.: US 2005/0279015 A1
(43) Pub. Date: Dec. 22, 2005

(54) Awesome rat & mouse trap

(76) Inventor: James R. Hall, Hartsville, SC (US)

Correspondence Address: MICHAEL A, MANN, NEXSEN PRUET, LLC, POST OFFICE DRAWER 2426, COLUMBIA, SC, 29202-2426, US

(21) Appl. No.: 10/870,267

(22) Filed: Jun. 17, 2004

(51) Int. Cl. A01M 23/08

(52) U.S. Cl. 43/66; 43/65

(57) ABSTRACT

A one way rodent trap, with an internal chamber, gated by a plunger and a slot, making use of the rodents strength to open the aperture large enough for it to go through, and when in the chamber, makes it impossible to exit. This device made of injected, molded, plastic, consisting of only two basic parts, is produced, and maintained, economically. An assembly that does not require any fastener or other fastening means. A device which traps the rodent, by humane means, and has an astucious, injected molded, design which integrates moveable parts molded into the trap. Such a trap has a top hinged door with a latching mechanism, for easy and safe removal of the live rodent.

### BACKGROUND OF THE INVENTION

The present invention is a unique concept of how to trap rodents, such as mice or rats, safely and surely, with the capacity to catch one or several. The trap system avoids bodily harm to the rodent and remains a humane process.

The Awesome Rat & Mouse Trap, is manufactured economically. It consists of two injected molded pieces, fitting within each other freely and not requiring any fasteners or other means of fastening.

These traps are used in building areas where an accumulation of rodents generally exist, such as the backyards of restaurants, farm stables, food manufacturing storage plants, military camps cooking area and anywhere there is disposable garbage.

Traditionally, through the ages, rodents all over the world were a constant and persistent pest and are still a danger to the health of human beings. They are known to be a source of great epidemic diseases. For centuries, people have used box traps with covers with a balance trigger using bait to catch one or two at a time.

In the last 150 years, a traditional mousetrap was conceived, and is still in use in very large quantities. These traps consist of a special finger-spring mounted on a board; one end of the finger-spring has a cross wire arm, which is retained by a hooked wire, acting as a trigger. These traps are relatively small and can be placed in a remote corner of the house or building, and if left for any length of time, produce an offensive order that permeates the building. This type of trap is very sensitive to handle and as the mouse approaches the bait and hits the trigger, it is hit violently, and if not dead, is injured and bleeds to death. If it is not removed immediately it begins to decay and becomes a health hazard.

Other traps use poison, which the mouse eats and then transfers the poison to their nests, which kills others that come in contact with it. When this happens it is usually behind a remote wall or in the ceiling, which is inaccessible and sometimes impossible, to retrieve the dead animals. This also presents a health hazard.

The Awesome Rat & Mouse Trap, removes these conditions by trapping the rodents and not hurting them and keeps them alive, in an accessible area, allowing the user to get them out and dispose of them in a controlled way.

### PRIOR ART

An organized search reveals, from a Class 43/58,145 Patents were found, scanned, and the abstract readout, the patent text and the drawings were studied.

These patents, and the most recent ones, do not show any infringement. U.S. Pat. No. 6,199,0314 B1 dated Mar. 13, 2001 is by Everett B. Ballard, which is an improved locking finger spring, guillotine, and is not relative to the proposed Disclosure.

U.S. Pat. No. 6,202,339 B1, dated Mar. 20, 2001 is by Henry E. Camppel, combines a closed box with, aperture and two walls directing the rodent toward the bait. As the rodent enters, the blind channel it steps over a sticky tape on the floor, which holds the creature by adhesion and is not relative to the proposed Disclosure.

U.S. Pat. No. 6,397,517 B1 dated Jun. 4, 2002 is by Rick Leyerie and Daniel C. Johnson. It is a high tech trap, with a labyrinth channel, that is set internally in a plastic box, with an arrangement of a blind passage, directing the rodents toward the bait and this leads them to be caught in a triggered, spring metal, trap. This is not relative to the proposed Disclosure.

The Awesome Trap concept of a one way passage, making use of the attractive scent and the rodents strength enticing it to raise the plunger, which can only be raised from the entrance. It is different and new to the art, in comparison in the field of existing patents reviewed.

### SUMMARY

The present invention consists of a one pieced cubicle shaped main body, which is an injected molded plastic box, which integrates several functional features. Also, a second piece is a hollow cylindrical plunger with an outer molded ring at its top edge. It is made of a thin wall with a closed bottom except for a small hole that is used to exhaust liquid, which could accidentally enter the plunger. Such a plunger being inserted, vertically into the chimney, which is centrally located over the channel and open to the outside partition having a vertical slotted area. This slot is large enough to allow small rodents to go through it. This new concept entices the rodent by the scent of the internally set bait. The plunger, when fully inserted, lets a very small area of the slot open so the rodent, which is attracted by the scent of the bait, with its desire to get at the bait, raises the light plunger upward, and opens a larger aperture of the slot. As the slot aperture becomes larger, the rodent jumps through it into the inside chamber to reach the bait that is in a far corner. As soon as he is away from the aperture, the plunger, by gravity, closes making it impossible for the rodent to reopen the aperture and is trapped. In this same way, several rodents can be trapped individually. Another side of the invention, is the astucious, molded, plastic design of the trap, which is unique. The life hinge covers are pre-stressed upward to allow the covers to rise by themselves above the latch to ease their openings. Another feature is, two outer integrated, molded, side latch mechanisms, which consists of “U” shaped brackets, rising latching pawls attached to the brackets bottom through a semi circular life hinge, acting as a curved, flat, section spring, that pushes the pawls constantly against the wall and the covers edge. The two covers, attached by a life hinge on the top of both end-walls, allows it to close or open the trap for the easy transferring of the rodent from inside to a box or a cage for extermination and incineration by the traps owner.

### BRIEF DRAWING DESCRIPTION

Sheet 1

FIG. 1-1 shows a perspective of the Awesome Trap seen at a 25° angle from the top with the plunger fully inserted and two fully opened trap doors.

Sheet 2

FIG. 2-1 shows a 3D transversal central cross section of the trap without the plunger.

FIG. 2-2 shows an orthogonal elevation cross section of the tunnel and chimney with the plunger fully inserted.

FIG. 2-3 shows a partial top view of the FIG. 2-2 views, showing a small hole in the bottom of the plunger.

Sheet 3

FIG. 3-1 shows a longitudinal central cross section of the trap with the rodent in the tunnel. The top half door is closed and is latched.

Sheet 4 FIG. 4-1 shows a partial orthogonal elevation cross section of the side latches at rest, with the door closed.

FIG. 4-2 shows a similar view to 4-1 with a finger retracting the pawls to let the two doors rise.

FIG. 4-3 shows an orthogonal top view of the latching mechanism of FIG. 4-1.

FIG. 4-4 shows a partial profile section of the covers fully closed and latched, fully open and raised slightly for handling.

FIG. 4-5 shows a sectional view of the cover, life hinge, wall attachment and the freedom of the door opening.

Sheet 5A

FIG. 5A-1 shows an orthogonal view of a right side elevation of the trap assembly.

Sheet 6A

FIG. 6A-1 shows an orthogonal top view projection from the 5A-1 view of the assembly.

### DETAILED DESCRIPTION OF THE PREFERRED EMBODIMENTS

Sheet 1

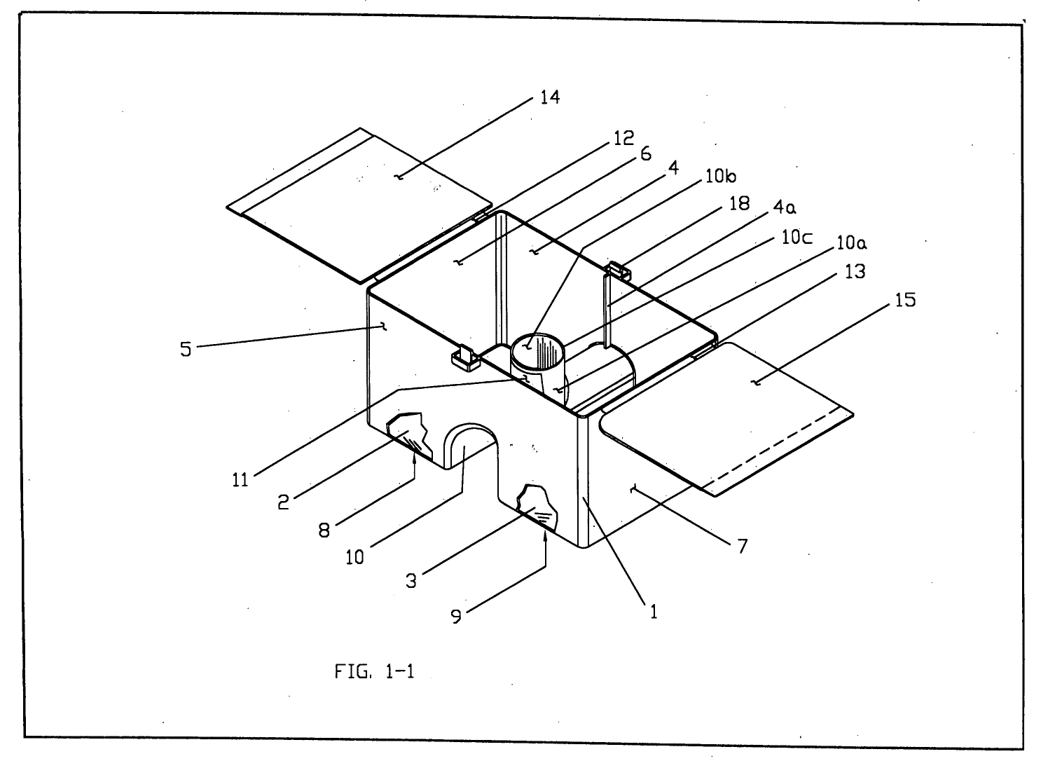

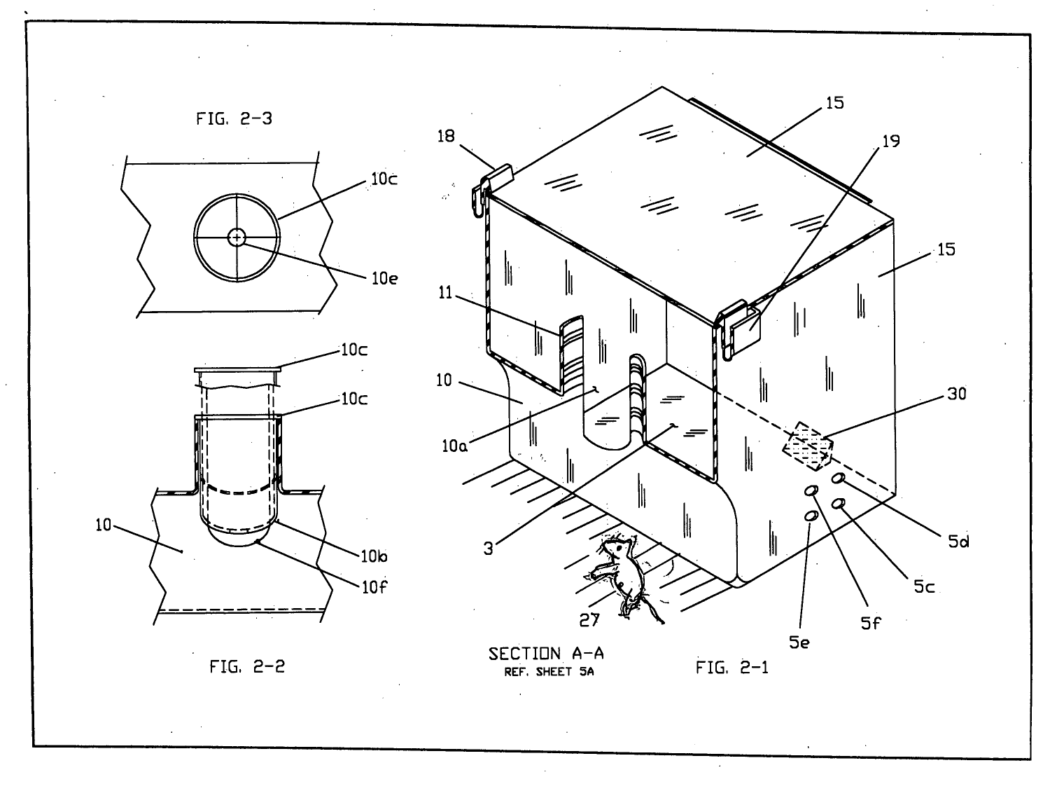

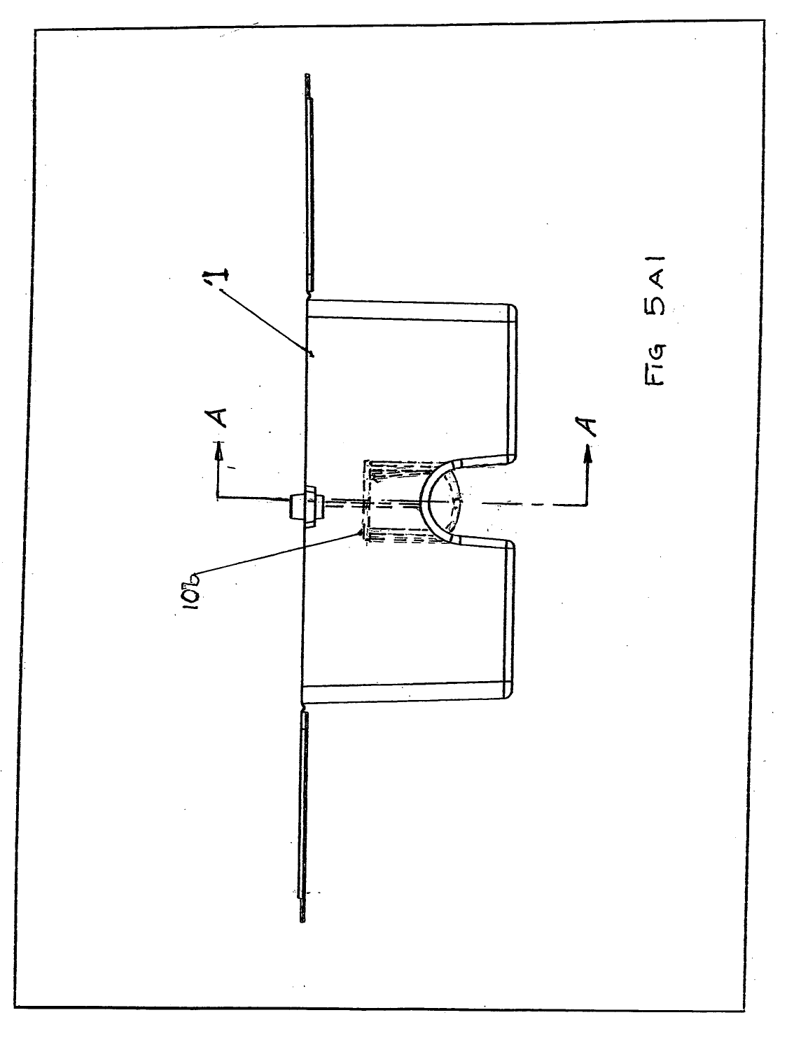

FIG. 1-1 shows a perspective of the trap 1 with its two half covers 14 & 15 completely open. The plunger, 10b, is fully inserted and is retained by its top rim, 10c. Basically, the trap consist of a double inner chamber, 2 & 3, enclosed by four upright sides, 4, 5, 6 & 7, of equal height, and a bottom with two sections, 8 & 9, which are separated, by a central inverted tunnel, 10, running across the width creating two chambers, 2 & 3. All these areas are integrated in one piece of molded injected plastic, forming an enclosure, called the trap body, also shown on FIG. 5A1. Midway through the tunnel, 10, and rising perpendicularly above it, on center, is an open hollow, cylindrical chimney, 11, which blends smoothly onto the tunnels outer opening, 10, Also, the rising chimney in the right side has a wide open slot, 10a. FIG. 2-2, sheet 2 is a perspective of the tunnel's chimney with the plunger installed.

Another area which has an integrally molded functional setting, consist of the top covers, 14 & 15, which connects with respective upright end side top edges 6 & 7, through some molded life hinges, 12 & 13. These life hinges are designed not only to create a flexible joint and joins the parts molded together, but also to give a stressful upward force to the covers. This design allows the covers to rise slightly above the latching pawl. This makes for the easy handling of the covers, as they are manually released, from the latches.

Another area is the latch mechanism sub-assemblies, 18 & 19, integrally molded to the outer side wall, 4 & 5, which consists of three parts; a “U” bracket, 4e, a curved life hinge, 4b, and a latching pawl, 4c, (better shown on Sheet 4, FIG. 4-1 and 4-2).

Sheet 2

FIG. 2-1 shows a central transversal cross section (AA ref FIG. 5A1) of the trap body with the rodent. It shows the right end chamber, 3, with half cross section of the tunnel, the chimney, 11, and the slot 10a. A partial view of the cover, 15, and the latches, 18 & 19, are also shown. The cover, 15, is closed and secured by the latches. Through the wall section, 5, shows an inside bait, 30, placed on an extreme inside bottom corner of the chamber. A side wall, 5, lower side as a perforation of 4 small holes, 5e, 5f, 5c, 5a, to let the bait scent sift out to attract the rodent, 27, passing by and prior to entering the tunnel. Then as shown, the rodent, 27, moves toward the center, attracted by the scent coming from the bottom of the small aperture made between the plunger bottom and slot end, 10f, (FIG. 2-2) to entice him to penetrate the chamber, 3.

FIG. 2-2 shows an elevated view of the plunger, 10b, fully inserted into the chimney cross section 11. Because of only a small aperture, 10f, the rodent must raise the light plunger sufficiently higher to obtain a larger aperture, and jump into the chamber, 3.

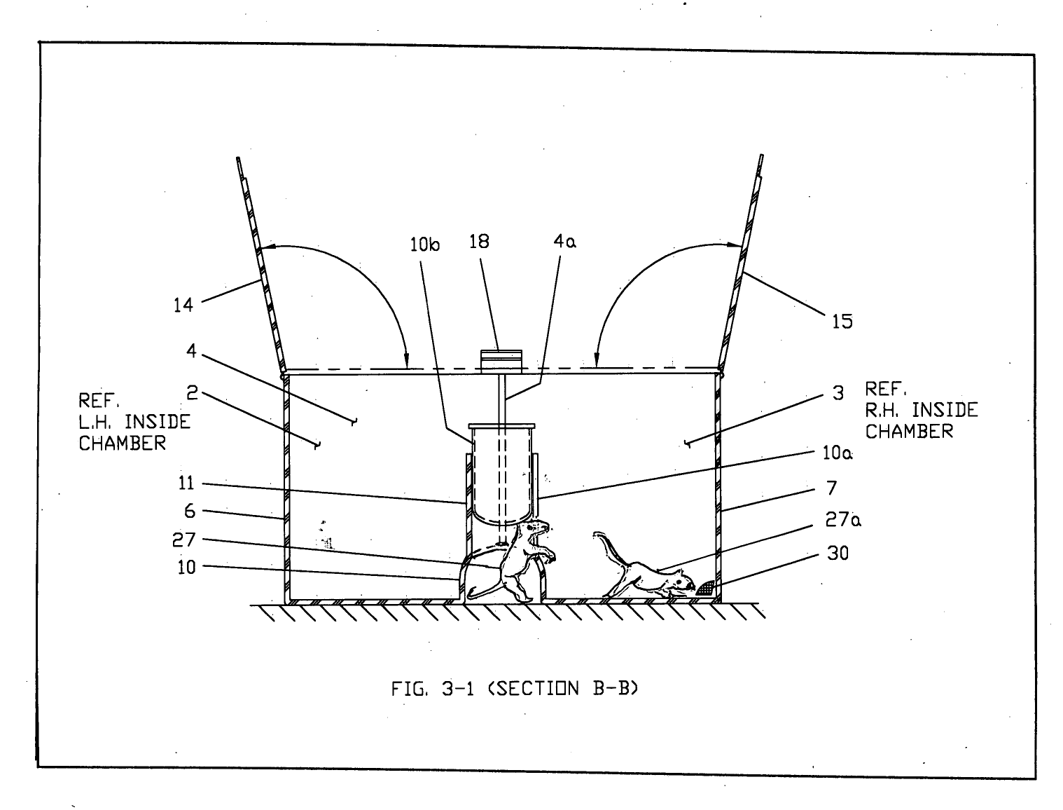

FIG. 2-3 shows a top view of the FIG. 2-2, showing the outer top edge, 10c, of the plunger, and the closed bottom of 10b, with a small hole, 10e, to let any liquid, such as rain, drain out of the hollow plunger, therefore, preserving its lightness.

Sheet 3

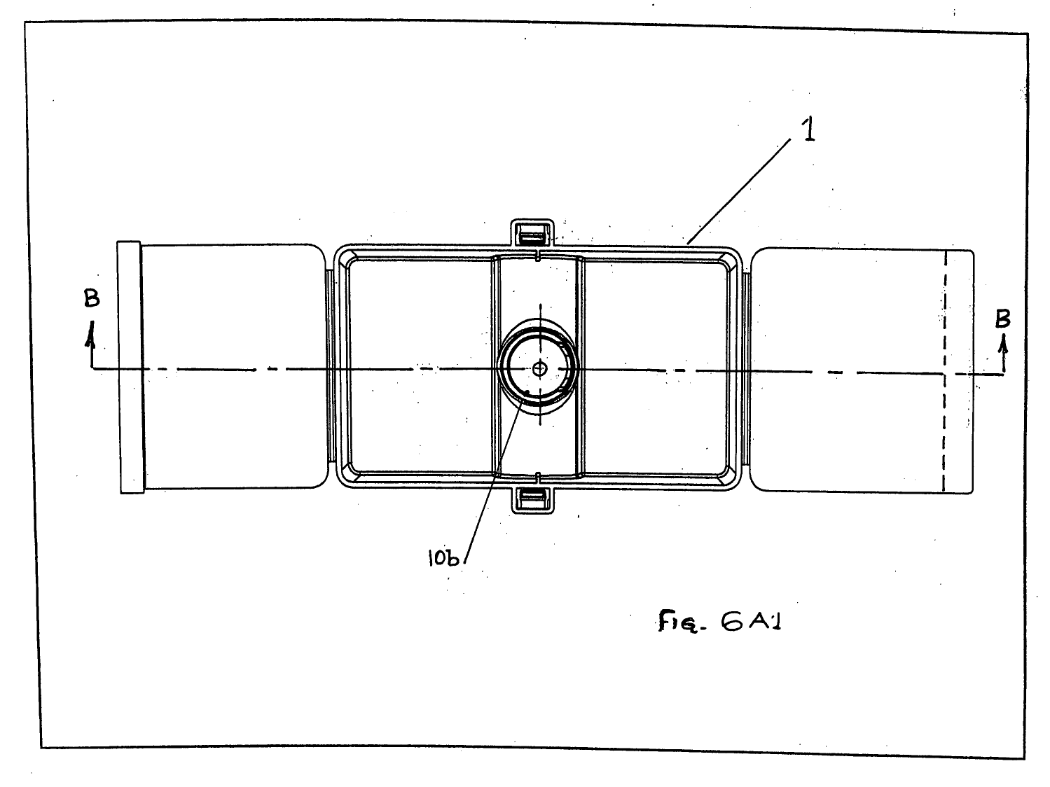

FIG. 3-1 shows a central longitudinal cross-section BB (shown on FIG. 6A-1, sheet 6A) of trap 1. The two covers, 14 & 15, are normally closed and retained by the latches, 18 & 19, (the cover contour of the door closes and is delineated by mixed lines) they are also shown held open by the life hinge, 12 & 13. The rodent, 27, raising by itself, the plunger, 10b, is shown ready to pass through the slot, and shows another rodent, 27a, already eating the bait. As the rodent gets in the chamber, 3, the light plunger falls back to its original stage, and blocks the larger aperture. This makes it is impossible for the rodent to raise the plunger, because of its offset position of the plungers axis. They are all trapped. The second chamber, 2, which the rodents have access to, allows the trap to increase the number of rodents caught.

Sheet 4

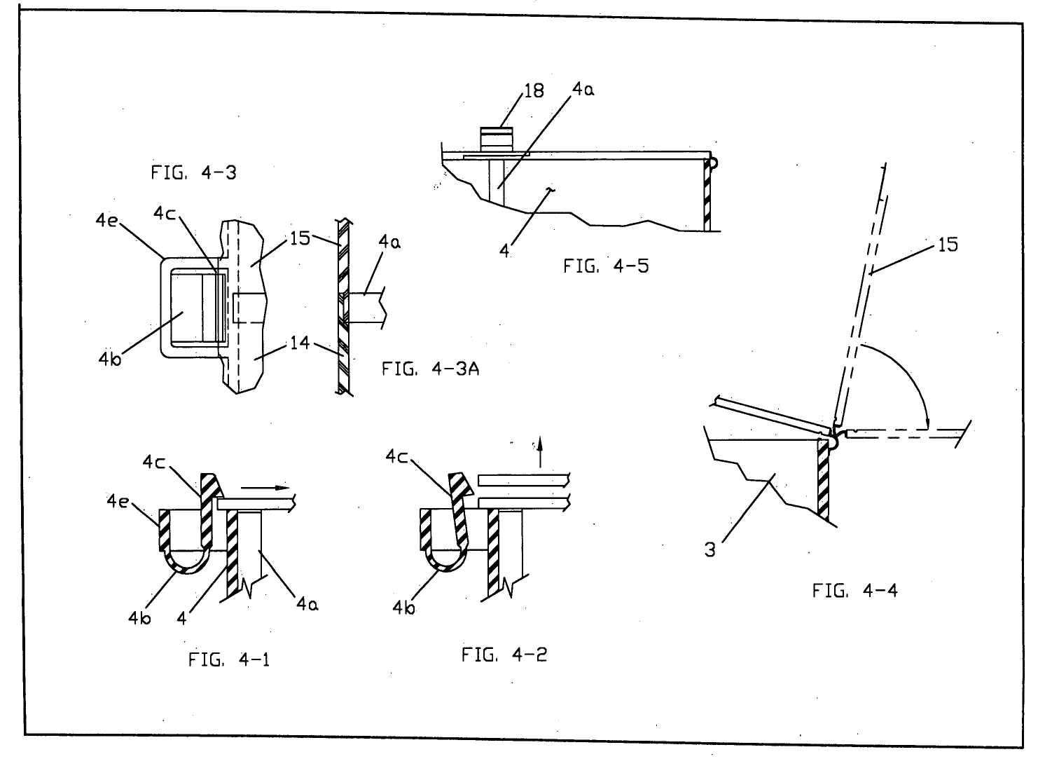

FIG. 4-1 shows a cross section of the lever latching mechanism, 18 on side 4 & 19 on side 5. It consists of a “U” bracket, 4e, a semi-circular hinge spring, 4b, joining the bracket to the latching pawl, 4c, integrally molded to the wall. The physical shape and dimensions of the beam of the hinge are such that the pawl, 4c, is normally loaded against the wall, 4. The pawl's, upper part, 4c, is profiled to let the covers snap under the pawl, automatically, as they are dropped and pushed to a closed position.

FIG. 4-2 shows a similar view of the pawl mechanism but with the pawl manually retracted on both sides, the doors springing open by themselves over the latched pawl area, making it easy to fully open the trap doors.

FIG. 4-3 shows an orthogonal top view of the latch assembly. The “U” bracket, 4e, the center hinge spring, 4b, and the latch pawls top edge, 4c, also internally to the wall, a rib, 4 and 5a, which runs the inside height of the wall, 4 & 5, and up to the top of the tunnel, is provided to extend the cover support.

FIG. 4-4 shows a partial elevated cross-section of the traps right side above the chamber, 3, showing the details of the life hinge connecting, through integral molding, the cover and to the rear side, 7, it also shows the door opening array, 15.

FIG. 4-5 shows a partial cross-section cut out of the cover, 15, in a closed, latched, position.

Sheet 5A

FIG. 5A1 shows an elevation of the trap assembly, where part 1 incorporates all the trap details and part 10b shows the plunger along a central line ending at arrows AA, indicating the section shown on FIG. 2-1.

Sheet 6A

FIG. 6A1 shows a top view of the assembly with the cover open, showing parts 1 and 10b, once again with a central line ending at arrows BB, indicating the view shown on FIG. 3-1,

1-12. (canceled)

13. A rodent trap, comprising:
(a) a closed body having
at least one lid,
a latch for holding said at least one lid closed,
an inverted tunnel formed in said body, running across said body and dividing said body into two chambers, and
a chimney in communication with said tunnel and extending upward from said inverted tunnel, said chimney having a top edge and a slot formed therein and dimensioned for a rodent to pass therethrough; and
(b) a plunger having a closed bottom with a hole formed therein and a top rim, said top rim holding said plunger on said top edge of said chimney, said plunger dimensioned to be raisable and to fall within said chimney of said body and to extend down said chimney far enough to leave only an aperture too small for a rodent to pass therethrough in said slot so that a rodent in said inverted tunnel must raise said plunger to enter said chambers through said slot.

14. The rodent trap of claim 13, wherein said chimney is centered in said inverted tunnel.

15. The rodent trap of claim 13, wherein said at least one lid is integrally molded with said body and connected thereto by life hinges.

16. The rodent trap of claim 13, wherein said latch further comprises:
a U-shaped bracket including a curved life hinge; and
a latching pawl, said bracket integrally connecting said latching pawl to said body.

17. The rodent trap of claim 13, wherein said body has holes formed therein to allow the scent of bait to pass therethrough.

18. A rodent trap, comprising:
(a) a closed body having
a lid,
a latch for holding said lid closed,
an inverted tunnel formed in said body, running across said body, and
a chimney in communication with said tunnel and extending upward from said inverted tunnel, said chimney having a top edge and a slot formed therein and dimensioned for a rodent to pass therethrough and into a chamber within said body; and
(b) a plunger having a closed bottom, said plunger dimensioned to be raisable within said chimney and to fall within said chimney of said body far enough to leave only an aperture in said slot too small for a rodent to pass therethrough so that a rodent in said inverted tunnel must raise said plunger to enter said chamber through said slot.

19. The rodent trap of claim 18, wherein said body and said plunger are made of injection molded plastic.

20. The rodent trap of claim 18, wherein said plunger has a top rim, said rim resting on said top edge of said chimney when said plunger is in said chimney.

21. The rodent trap of claim 18, wherein said plunger has a closed bottom with a hole formed therein.
